(19) United States
(12) Patent Application Publication
(10) Pub. No.: US 2022/0288624 A1
(43) Pub. Date: Sep. 15, 2022

(54) METHOD OF MANUFACTURING TUBULAR MEMBER FOR EXHAUST GAS TREATMENT DEVICE, AND COATING FILM FORMING DEVICE

(71) Applicant: NGK INSULATORS, LTD., Nagoya-City (JP)

(72) Inventors: Kodai KATO, Iwakura-City (JP); Ryo FUJIMURA, Komaki-City (JP); Akifumi NISHIO, Ena-City (JP)

(73) Assignee: NGK INSULATORS, LTD., Nagoya-City (JP)

(21) Appl. No.: 17/643,602

(22) Filed: Dec. 10, 2021

(30) Foreign Application Priority Data
Mar. 15, 2021 (JP) 2021-041348

(51) Int. Cl. B05C 7/08; B05D 7/22; B05D 1/00; B05D 3/02

(52) U.S. Cl. CPC B05C 7/08; B05D 7/22; B05D 1/002; B05D 3/0254; F01N 13/14

(57) ABSTRACT

A method of manufacturing a tubular member for an exhaust gas treatment device according to at least one embodiment of the present invention, the tubular member including a tubular main body made of a metal and an insulating layer formed on at least an inner peripheral surface of the tubular main body, the insulating layer containing glass, includes steps of: forming a coating film by bringing a coating liquid for insulating layer formation supplied to the tubular main body into contact with a contact member; and firing the coating film to obtain the insulating layer.

### CROSS-REFERENCE TO RELATED APPLICATION

The present application claims priority from Japanese Application JP 2021-41348 filed on Mar. 15, 2021, the content of which is hereby incorporated by reference into this application.

### BACKGROUND OF THE INVENTION

### 1. Field of the Invention

One or more embodiments of the present invention relate to a method of manufacturing a tubular member for an exhaust gas treatment device, and to a coating film forming device.

### 2. Description of the Related Art

A catalyst support obtained by causing a support to support a catalyst is used for treatment of a harmful substance in an exhaust gas discharged from a vehicle engine. In this case, there is a problem in that, when a temperature of the catalyst is low at a start of the engine, the temperature of the catalyst is not increased to a predetermined temperature, resulting in a failure to sufficiently purify the exhaust gas. In order to solve such problem, progress is being made in development of an exhaust gas treatment device using an electric heating catalyst (EHC), in which a support having conductivity is energized to cause the support to generate heat, to thereby increase the temperature of the catalyst supported on the support to its active temperature before the start of the engine or at the start of the engine.

In the exhaust gas treatment device, the EHC is typically housed in a tubular member made of a metal (sometimes referred to as “can”). The EHC can be excellent in purification efficiency for the exhaust gas at the start of the vehicle, but electricity leaks from the EHC to surrounding exhaust piping, resulting in a failure, such as a reduction in purification efficiency, in some cases. In order to solve such problem, in each of Japanese Patent No. 5408341 and Japanese Patent Application Laid-open No. 2012-154316, there is a disclosure that the leakage of electricity is prevented by forming an insulating layer on an inner peripheral surface of the tubular member.

### SUMMARY OF THE INVENTION

The insulating layer may be typically obtained by applying a coating liquid for insulating layer formation to form a coating film and firing the coating film. From the viewpoint of obtaining excellent insulating performance, for example, the thickness of the coating film to be formed is required to be increased. However, when the thickness is increased, the yield for obtaining the coating film is reduced in some cases.

One or more embodiments of the present invention have been made in view of the problems described above, an object thereof is to form an insulating layer with a high yield.

A method of manufacturing a tubular member for an exhaust gas treatment device according to at least one embodiment of the present invention, the tubular member including a tubular main body made of a metal and an insulating layer formed on at least an inner peripheral surface of the tubular main body, the insulating layer containing glass, includes steps of: forming a coating film by bringing a coating liquid for insulating layer formation supplied to the tubular main body into contact with a contact member; and firing the coating film to obtain the insulating layer.

In at least one embodiment, the coating liquid for insulating layer formation has a viscosity of 10 dPa·s or more.

In at least one embodiment, the contact with the contact member is performed while the tubular main body and/or the contact member is rotated with a length direction of the tubular main body being a rotation axis.

In at least one embodiment, the method further includes a step of heating the tubular main body.

In at least one embodiment, the insulating layer has a thickness of from 30 μm to 800 μm.

In at least one embodiment, the contact member is configured of a flexible material having a Shore A hardness of from 30 to 50. The contact member may be configured to allow adjustment of a pressing amount of the contact member against the inner peripheral surface of the tubular main body.

In at least one embodiment, the contact member is configured of a resin having an R-scale Rockwell hardness of from 85 to 110. The contact member may be arranged at a predetermined distance from the tubular main body.

A coating film forming device according to at least one embodiment of the present invention includes: a rotating unit configured to fix a tubular main body made of a metal, and to rotate the tubular main body with a length direction thereof being a rotation axis; a supplying unit configured to supply a coating liquid for insulating layer formation toward an inner peripheral surface of the tubular main body; and a contact member arranged in the tubular main body, the contact member being configured to be brought into contact with the coating liquid for insulating layer formation.

In at least one embodiment, the device further includes a heating unit configured to heat the tubular main body.

In at least one embodiment, the contact member is configured of a flexible material having a Shore A hardness of from 30 to 50. The contact member may be configured to allow adjustment of a pressing amount of the contact member against the inner peripheral surface of the tubular main body.

In at least one embodiment, the contact member is configured of a resin having an R-scale Rockwell hardness of from 85 to 110. The contact member may be arranged at a predetermined distance from the tubular main body.

### BRIEF DESCRIPTION OF THE DRAWINGS

FIG. 1 is a sectional view for illustrating a tubular member to be used in an exhaust gas treatment device according to at least one embodiment of the present invention.

FIG. 2 is a schematic view for illustrating the entire configuration of a coating film forming device according to at least one embodiment of the present invention.

FIG. 3 is a schematic view for illustrating a positional relationship between a tubular main body and a contact member in a first embodiment.

FIG. 4 is a schematic view for illustrating a positional relationship between the tubular main body and the contact member in a second embodiment.

FIG. 5 is a schematic view for illustrating a positional relationship between the tubular main body and the contact member in a third embodiment.

FIG. 6 is a schematic view for illustrating a positional relationship between the tubular main body and the contact member in a fourth embodiment.

FIG. 7 is a schematic view for illustrating a positional relationship between the tubular main body and the contact member in a fifth embodiment.

FIG. 8 is a schematic sectional view for illustrating the schematic configuration of the exhaust gas treatment device according to at least one embodiment of the present invention.

FIG. 9 is a view of the exhaust gas treatment device of FIG. 8 seen from the direction of the arrow IX.

### DESCRIPTION OF THE EMBODIMENTS

Embodiments of the present invention are described below with reference to the drawings. However, the present invention is not limited to these embodiments.

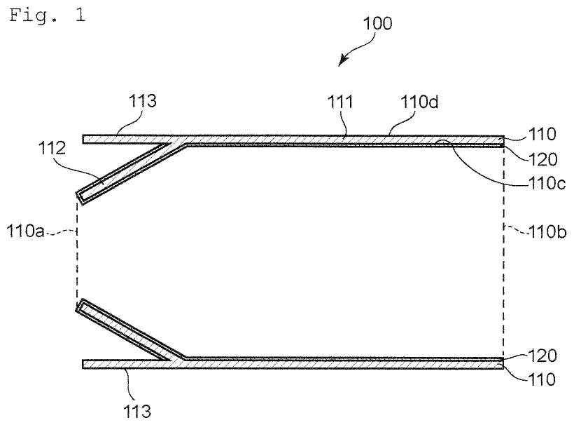

FIG. 1 is a sectional view for illustrating the schematic configuration of a tubular member to be used in an exhaust gas treatment device according to at least one embodiment of the present invention. A tubular member 100 includes a tubular main body 110 made of a metal and an insulating layer 120 formed on the tubular main body 110.

The tubular main body 110 has a straight portion 111 of a cylindrical shape and a reduced diameter portion 112 whose inner diameter is continuously reduced toward a first end surface 110a side (left side or upstream side in FIG. 1). In addition to such reduced diameter portion, for example, another member (not shown) may be combined to form a complicated structure. Specifically, an extending portion 113 extending on the first end surface 110a side is formed on the end portion of the straight portion 111 on the first end surface 110a side, and the reduced diameter portion 112 is surrounded by the extending portion 113. Another member (not shown) within which the reduced diameter portion 112 can be housed, and the extending portion 113 may be fitted together to form a complicated structure.

As a material for forming the tubular main body 110, there are given, for example, stainless steel, a titanium alloy, a copper alloy, an aluminum alloy, and brass. Of those, stainless steel is preferred because of high endurance reliability and low cost.

The thickness of the tubular main body 110 may be, for example, from 0.1 mm to 10 mm, from 0.3 mm to 5 mm, or from 0.5 mm to 3 mm from the viewpoint of endurance reliability. The length of the tubular main body 110 may be appropriately set in accordance with the sizes, number, and arrangement of objects to be housed, such as a catalyst support to be described later, purposes, and the like. The length of the tubular main body may be, for example, from 30 mm to 600 mm, from 40 mm to 500 mm, or from 50 mm to 400 mm. The length of the tubular main body is preferably larger than the length of an electric heating catalyst support to be described later. In this case, the electric heating catalyst support may be arranged so that the electric heating catalyst support is not exposed from the tubular main body.

The surface (e.g., inner peripheral surface) of the tubular main body 110 may be subjected to surface treatment (not shown). A typical example of the surface treatment is treatment such as blasting. Through the roughening treatment, adhesiveness between the tubular main body 110 and the insulating layer 120 can be improved.

The insulating layer 120 may impart an electrical insulating property between the tubular member 100 and the objects to be housed, such as a catalyst support to be described later. Herein, the electrical insulating property typically satisfies JIS standard D5305-3 from the viewpoint of suppressing the leakage of electricity to surrounding exhaust piping, and an insulation resistance value per unit voltage is, for example, 100 Ω/V or more. The insulating layer 120 preferably has moisture impermeability and moisture non-absorbability. Specifically, the insulating layer 120 is preferably configured to be so dense as to prevent the permeation and absorption of water. Regarding denseness, the insulating layer has a porosity of, for example, 10% or less, and for example, 8% or less.

The insulating layer 120 contains glass. The composition of the glass is not particularly limited, and glasses having various compositions may be used. Specific examples of the glass include silicate glass, barium glass, boron glass, strontium glass, aluminosilicate glass, soda zinc glass, and soda barium glass. Those glasses may be used alone or in combination thereof.

The glass is preferably crystalline substance-containing glass. When the glass contains a crystalline substance, an insulating layer that is less liable to soften and deform even under high temperature (e.g., 750° C. or more) can be obtained. In addition, an insulating layer excellent in adhesiveness with the tubular main body can be obtained. Specifically, a difference in thermal expansion coefficient between the insulating layer and the tubular main body (metal) can be reduced, and hence a thermal stress occurring at the time of heating can be reduced. The presence or absence of the crystalline substance (crystal) may be determined by an X-ray diffraction method.

In at least one embodiment of the present invention, the glass contains silicon and boron. The glass may contain silicon in the form of SiO₂, and the glass may contain boron in the form of B₂O₃. Specifically, the glass is SiO₂—B₂O₃-based glass (borosilicate glass). The content of silicon in the glass is preferably from 5 mol % to 50 mol %, more preferably from 7 mol % to 45 mol %, still more preferably from 10 mol % to 40 mol %. The content of boron in the glass is preferably from 5 mol % to 60 mol %, more preferably from 7 mol % to 57 mol %, still more preferably from 8 mol % to 55 mol %.

The glass may contain, in addition to silicon and boron, another component (metal element), such as magnesium, barium, lanthanum, zinc, or calcium. For example, the glass may further contain magnesium. The glass may contain magnesium in the form of MgO. In this case, the content of magnesium in the glass is preferably 10 mol % or more, more preferably from 15 mol % to 55 mol %. In addition, for example, the glass may further contain barium. The glass may contain barium in the form of BaO. In this case, the content of barium in the glass is preferably from 3 mol % to 30 mol %, more preferably from 5 mol % to 25 mol %, still more preferably from 6 mol % to 20 mol %.

Herein, the “content of an element in the glass” is the molar ratio of atoms of the element in question with respect to 100 mol % of the amount of all atoms in the glass except oxygen atoms. The amount of atoms of each element in the glass is measured by, for example, inductively coupled plasma (ICP) emission spectrometry.

The thickness of the insulating layer 120 is, for example, preferably 30 μm or more, more preferably 50 μm or more, still more preferably 100 μm or more, particularly preferably 150 μm or more from the viewpoint of obtaining an excellent insulating property. Meanwhile, the thickness of the insulating layer 120 is, for example, 800 μm or less, preferably 600 μm or less.

In the illustrated example, the insulating layer 120 is formed over the entirety of an inner peripheral surface 110c of the tubular main body 110. In addition, in the end portion on the first end surface 110a side, the insulating layer 120 is formed to range from the inner peripheral surface 110c to an outer peripheral surface 110d. The region in which the insulating layer is formed may be appropriately set in accordance with the sizes, number, and arrangement of objects to be housed, such as an electric heating catalyst support to be described later, purposes, and the like. For example, unlike the illustrated example, in the inner peripheral surface 110c of the tubular main body 110, a non-formation region in which the insulating layer 120 is not formed may be arranged in an end portion on a second end surface 110b side.

The insulating layer 120 may be typically obtained by applying a coating liquid for insulating layer formation to the tubular main body 110 to form a coating film and firing the coating film.

The coating film is formed using a contact member to be brought into contact with the coating liquid for insulating layer formation. Hitherto, as a method of forming an insulating layer, a coating film has been formed by a spray method. However, this method, in which the coating liquid for insulating layer formation is liable to be scattered, cannot be said to be sufficient in terms of yield. Meanwhile, when the contact member is used, for example, the coating liquid for insulating layer formation supplied toward the tubular main body is not scattered, and hence a coating film having a desired thickness can be uniformly formed with a high yield. In addition, the occurrence of a defect, such as a pinhole or a crack, can also be suppressed, and hence an insulating layer excellent in insulating performance can be formed.

The coating liquid for insulating layer formation is typically a slurry (dispersion) containing a glass source and a solvent. The coating liquid for insulating layer formation may contain raw materials or glass frit as the glass source. In at least one embodiment of the present invention, the coating liquid for insulating layer formation is obtained by producing glass frit from raw materials and mixing the resultant glass frit with the solvent. Herein, the “solvent” refers to a liquid medium contained in the coating liquid for insulating layer formation, and is a concept encompassing solvent and dispersion medium.

Specific examples of the raw material include silica sand (silicon source), dolomite (magnesium and calcium source), alumina (aluminum source), boric acid, barium oxide, lanthanum oxide, zinc oxide (zinc flower), and strontium oxide. The raw material is not limited to an oxide, and may also be, for example, a carbonate or a hydroxide. The glass frit is typically obtained by pulverizing glass produced by synthesis from raw materials (e.g., pulverizing the glass in two stages of coarse pulverization and fine pulverization). The synthesis is typically performed by melting under high temperature (e.g., 1,200° C. or more) for a long period of time.

The solvent may be water or an organic solvent. The solvent is preferably water or a water-soluble organic solvent, such as an alcohol, and is more preferably water. The blending amount of the solvent is, for example, preferably from 50 parts by mass to 300 parts by mass, more preferably from 80 parts by mass to 200 parts by mass with respect to 100 parts by mass of the glass source.

The coating liquid for insulating layer formation (slurry) may contain a slurry aid. Examples of the slurry aid include a resin, a plasticizer, a dispersant, a thickener, and various other additives. The kinds, number, combination, blending amounts, and the like of the slurry aids may be appropriately set in accordance with purposes.

The viscosity of the coating liquid for insulating layer formation (at the time of its application) is preferably 10 dPa·s or more, more preferably 15 dPa·s or more. Meanwhile, the viscosity of the coating liquid for insulating layer formation (at the time of its application) is, for example, 40 dPa·s or less. When the contact member is used, the viscosity of the coating liquid for insulating layer formation can be set to a high viscosity. The viscosity of the coating liquid for insulating layer formation is controlled by, for example, adjusting the blending amount of the solvent.

For example, the thickness of the coating film of the coating liquid for insulating layer formation only needs to be appropriately adjusted in accordance with the desired thickness of the insulating layer (after firing). Specifically, the thickness of the coating film may be set to be from about 2 to about 5 times as large as the thickness of the insulating layer.

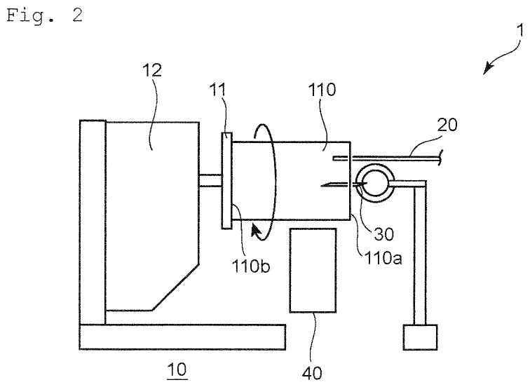

FIG. 2 is a schematic view for illustrating the entire configuration of a coating film forming device according to at least one embodiment of the present invention. Specifically, FIG. 2 is a side view of a coating film forming device 1. The coating film forming device 1 includes: a rotating unit 10 for fixing and rotating the tubular main body 110; a supplying unit 20 for supplying a coating liquid for insulating layer formation toward the surface (inner peripheral surface in the illustrated example) of the tubular main body 110; a plate-shaped contact member 30 to be brought into contact with the coating liquid for insulating layer formation; and a heating unit 40 for heating the tubular main body 110. In FIG. 2, parts of the supplying unit 20 and the contact member 30 are invisible from the outside, but are illustrated in solid lines for the sake of convenience.

The rotating unit 10 includes: a table 11 to whose surface the tubular main body 110 is to be fixed; and a driving portion 12 for rotating the table 11. The second end surface 110b is fixed to the table 11 so that the tubular main body 110 may be rotated with its length direction being a rotation axis.

The heating unit 40 heats the tubular main body 110 by blowing hot air against the outer peripheral surface of the tubular main body 110.

The supplying unit 20 supplies a coating liquid for insulating layer formation, which is supplied from a device (not shown) for supplying a coating liquid for insulating layer formation, toward the surface of the tubular main body 110. The contact member 30 is brought into contact with the coating liquid for insulating layer formation supplied from the supplying unit 20, and thus the coating liquid for insulating layer formation is uniformly applied to a desired region in the surface of the tubular main body 110. The contact member 30 is formed of, for example, a spatula. The contact member 30 may or may not have flexibility. The supplying unit 20 and the contact member 30 may be, for example, arranged to be movable through use of a moving device (not shown) (e.g., a uniaxial robot) for enabling their movement in the length direction of the tubular main body 110.

The applied coating liquid for insulating layer formation may be subjected to drying treatment by heating. The heating of the tubular main body 110 by the heating unit 40 may be performed at any appropriate timing. Specifically, the heating may be performed: before the application of the coating liquid for insulating layer formation; during the application; after the application; or a combination thereof. In addition, the heating may be performed continuously, or may be performed intermittently. The heating temperature of the tubular main body is, for example, from 50° C. to 120° C. When the application of the coating liquid for insulating layer formation is accompanied by heating the tubular main body 110, drying of the coating liquid for insulating layer formation applied onto the surface of the tubular main body 110 is promoted, and hence a coating film having a more uniform thickness can be formed.

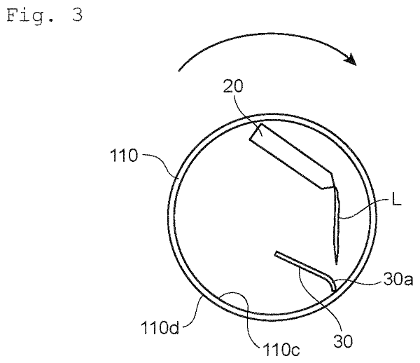

FIG. 3 is a schematic view for illustrating a positional relationship between the tubular main body and the contact member in a first embodiment. In this embodiment, the contact member (spatula) 30 has flexibility. For example, the contact member 30 is formed of a flexible material having a Shore A hardness of from 30 to 50. As a specific example, the contact member 30 is formed of a urethane resin. The contact member 30 is arranged under a state in which the flat surface of an end portion 30a thereof is pressed against the inner peripheral surface 110c of the tubular main body 110. Under this state, while the tubular main body 110 is rotated in the arrow direction, a coating liquid L for insulating layer formation is supplied from the supplying unit 20 to the upper surface (surface forming an acute angle with respect to the inner peripheral surface 110c of the tubular main body 110) of the contact member 30 to form a coating film. As described above, the timing of the heating is not particularly limited. For example, after the coating liquid L for insulating layer formation has been applied, the contact member 30 is separated from the tubular main body 110 before the region in which the coating liquid L for insulating layer formation is applied is heated. In this embodiment, for example, through adjustment of the rotation speed of the tubular main body 110, the pressing amount of the contact member 30, and the supply amount of the coating liquid L for insulating layer formation, a coating film having a desired thickness can be formed.

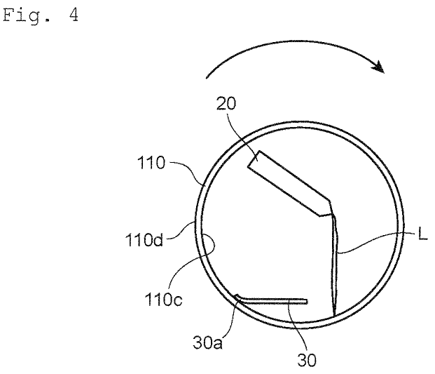

FIG. 4 is a schematic view for illustrating a positional relationship between the tubular main body and the contact member in a second embodiment. This embodiment differs from the first embodiment in that the coating liquid L for insulating layer formation is supplied to the inner peripheral surface 110c of the tubular main body 110.

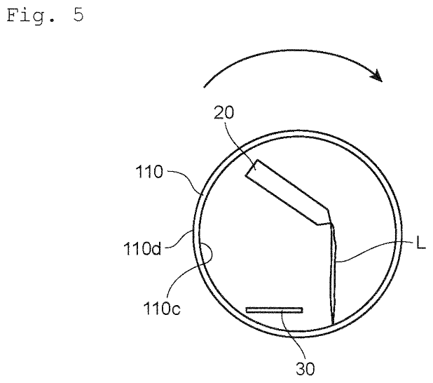

FIG. 5 is a schematic view for illustrating a positional relationship between the tubular main body and the contact member in a third embodiment. In this embodiment, the contact member 30 does not have flexibility, and is formed of, for example, a resin having an R-scale Rockwell hardness of from 85 to 110. The contact member 30 is arranged at a predetermined distance from the inner peripheral surface 110c of the tubular main body 110. Under this state, while the tubular main body 110 is rotated in the arrow direction, the coating liquid L for insulating layer formation is supplied to the inner peripheral surface 110c of the tubular main body 110 to form a coating film. Specifically, through adjustment of the distance between the inner peripheral surface 110c of the tubular main body 110 and the contact member 30, for example, a coating film having a desired thickness can be formed without performing recoating. The predetermined distance may be adjusted in accordance with, for example, the thickness of the insulating layer to be formed. In addition, as the contact member 30 is not pressed against the tubular main body 110, for example, a problem of wear of the contact member 30 by the tubular main body 110 that has been subjected to the surface roughening treatment does not occur. The shape of the contact member 30 may be reflected in the surface shape of the coating film to be obtained, and hence, for example, a linear portion of the contact member 30 is brought into contact with the coating liquid L for insulating layer formation. In addition, the surface shape of the tubular main body 110 may be reflected in the thickness of the coating film to be obtained, and hence, for example, the tubular main body 110 preferably has a high degree of circularity in a section thereof.

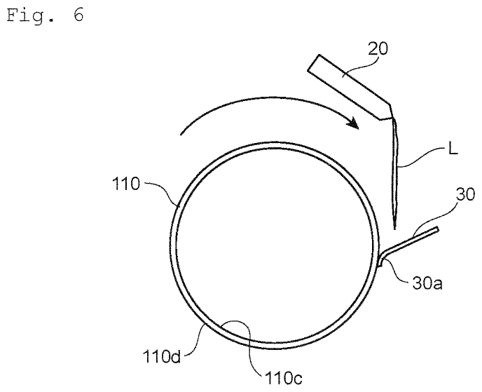

FIG. 6 is a schematic view for illustrating a positional relationship between the tubular main body and the contact member in a fourth embodiment. In this embodiment, the contact member 30 has flexibility, and is arranged under a state in which the flat surface of the end portion 30a thereof is pressed against the outer peripheral surface 110d of the tubular main body 110. Under this state, while the tubular main body 110 is rotated in the arrow direction, the coating liquid L for insulating layer formation is supplied to the upper surface (surface forming an acute angle with respect to the outer peripheral surface 110d of the tubular main body 110) of the contact member 30 to form a coating film on the outer peripheral surface 110d of the tubular main body 110.

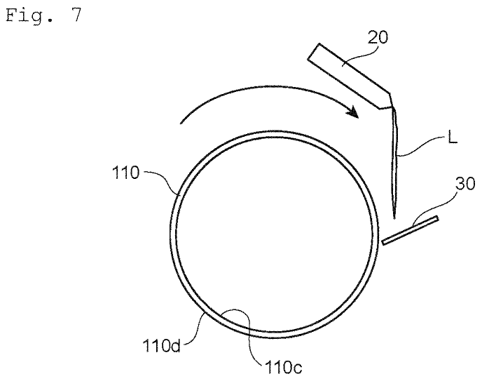

FIG. 7 is a schematic view for illustrating a positional relationship between the tubular main body and the contact member in a fifth embodiment. This embodiment differs from the fourth embodiment in that the contact member 30 does not have flexibility, and that the contact member 30 is arranged at a predetermined distance from the outer peripheral surface 110d of the tubular main body 110.

As described above, the obtained coating film is fired. A firing temperature is preferably 1,100° C. or less, more preferably from 600° C. to 1,100° C., still more preferably from 700° C. to 1,050° C. A firing time is, for example, from 5 minutes to 30 minutes, or may be from 8 minutes to 15 minutes.

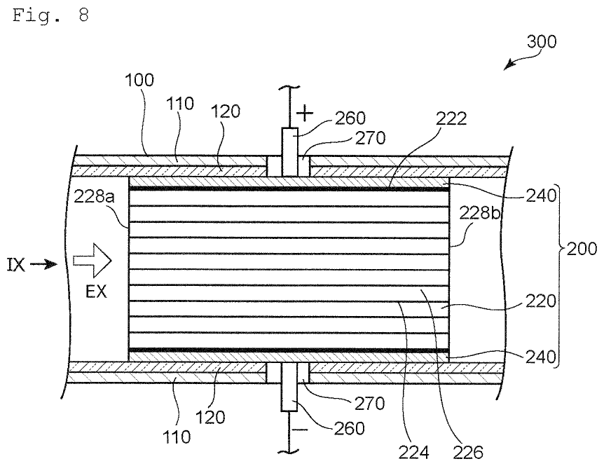

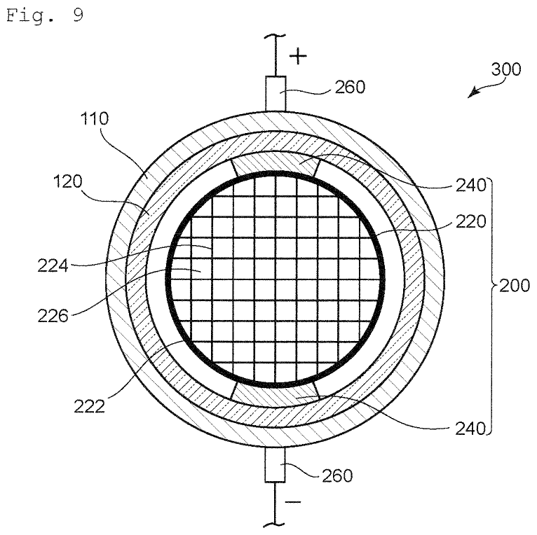

FIG. 8 is a schematic sectional view for illustrating the schematic configuration of the exhaust gas treatment device according to at least one embodiment of the present invention, and FIG. 9 is a view of an exhaust gas treatment device 300 of FIG. 8 seen from the direction of the arrow IX. The exhaust gas treatment device 300 is installed in a flow path through which an exhaust gas from an engine is to be flowed. In FIG. 8, as indicated by the arrow EX, the exhaust gas flows from left to right in the exhaust gas treatment device 300.

The exhaust gas treatment device 300 includes the tubular member 100 and an electric heating catalyst support (hereinafter sometimes referred to simply as “catalyst support”) 200 housed in the tubular member 100 and capable of heating the exhaust gas.

The catalyst support 200 has a shape corresponding to the shape of the tubular member 100, and is coaxially housed in the tubular member 100. The catalyst support 200 is housed so as to be brought into contact with the inner peripheral surface of the tubular member 100, but may be, for example, housed under a state in which the outer peripheral surface of the catalyst support 200 is covered with a holding mat (not shown).

The catalyst support 200 includes a honeycomb structure portion 220 and a pair of electrode portions 240 arranged on a side of the honeycomb structure portion 220 (typically so as to be opposed to each other across a central axis of the honeycomb structure portion). The honeycomb structure portion 220 includes an outer peripheral wall 222 and partition walls 224 which are arranged on an inner side of the outer peripheral wall 222 and which define a plurality of cells 226 extending from a first end surface 228a to a second end surface 228b to form the exhaust gas flow path. The outer peripheral wall 222 and the partition walls 224 are typically formed of conductive ceramics. The pair of electrode portions 240 and 240 are provided with terminals 260 and 260, respectively. One terminal is connected to a positive electrode of a power supply (e.g., a battery), and the other terminal is connected to a negative electrode of the power supply. On the periphery of the terminals 260 and 260, covers 270 and 270 each made of an insulating material are arranged so as to insulate the tubular main body 110 and the insulating layer 120 from the terminals 260.

The catalyst is typically supported by the partition walls 224. When the catalyst is supported by the partition walls 224, CO, NOₓ, a hydrocarbon, and the like in the exhaust gas passing through the cells 226 can be formed into harmless substances by the catalytic reaction. The catalyst may preferably contain a noble metal (e.g., platinum, rhodium, palladium, ruthenium, indium, silver, or gold), aluminum, nickel, zirconium, titanium, cerium, cobalt, manganese, zinc, copper, tin, iron, niobium, magnesium, lanthanum, samarium, bismuth, barium, and a combination thereof.

The present invention is not limited to the embodiments described above, and various modifications may be made thereto. For example, the configuration shown in each of the embodiments may be replaced by substantially the same configuration, a configuration having the same action and effect, or a configuration which may achieve the same object.

The tubular member for an exhaust gas treatment device obtained by the manufacturing method according to at least one embodiment of the present invention can be suitably used for the treatment (purification) of an exhaust gas from an internal combustion engine.

According to at least one embodiment of the present invention, the insulating layer can be formed with a high yield.

Many other modifications will be apparent to and be readily practiced by those skilled in the art without departing from the scope and spirit of the invention. It should therefore be understood that the scope of the appended claims is not intended to be limited by the details of the description but should rather be broadly construed.

What is claimed is:

1. A method of manufacturing a tubular member for an exhaust gas treatment device, the tubular member including a tubular main body made of a metal and an insulating layer formed on at least an inner peripheral surface of the tubular main body, the insulating layer containing glass,
the method comprising steps of:
forming a coating film by bringing a coating liquid for insulating layer formation supplied to the tubular main body into contact with a contact member; and
firing the coating film to obtain the insulating layer.

2. The manufacturing method according to claim 1, wherein the coating liquid for insulating layer formation has a viscosity of 10 dPa·s or more.

3. The manufacturing method according to claim 1, wherein the contact with the contact member is performed while the tubular main body and/or the contact member is rotated with a length direction of the tubular main body being a rotation axis.

4. The manufacturing method according to claim 1, further comprising a step of heating the tubular main body.

5. The manufacturing method according to claim 1, wherein the insulating layer has a thickness of from 30 μm to 800 μm.

6. The manufacturing method according to claim 1, wherein the contact member is configured of a flexible material having a Shore A hardness of from 30 to 50.

7. The manufacturing method according to claim 6, wherein the contact member is configured to allow adjustment of a pressing amount of the contact member against the inner peripheral surface of the tubular main body.

8. The manufacturing method according to claim 1, wherein the contact member is configured of a resin having an R-scale Rockwell hardness of from 85 to 110.

9. The manufacturing method according to claim 8, wherein the contact member is arranged at a predetermined distance from the tubular main body.

10. A coating film forming device, comprising:
a rotating unit configured to fix a tubular main body made of a metal, and to rotate the tubular main body with a length direction thereof being a rotation axis;
a supplying unit configured to supply a coating liquid for insulating layer formation toward an inner peripheral surface of the tubular main body; and
a contact member arranged in the tubular main body, the contact member being configured to be brought into contact with the coating liquid for insulating layer formation.

11. The coating film forming device according to claim 10, further comprising a heating unit configured to heat the tubular main body.

12. The coating film forming device according to claim 10, wherein the contact member is configured of a flexible material having a Shore A hardness of from 30 to 50.

13. The coating film forming device according to claim 12, wherein the contact member is configured to allow adjustment of a pressing amount of the contact member against the inner peripheral surface of the tubular main body.

14. The coating film forming device according to claim 10, wherein the contact member is configured of a resin having an R-scale Rockwell hardness of from 85 to 110.

15. The coating film forming device according to claim 14, wherein the contact member is arranged at a predetermined distance from the tubular main body.
